(19) United States
(12) Patent Application Publication
(10) Pub. No.: US 2023/0051582 A1
(43) Pub. Date: Feb. 16, 2023

(54) ROTOR, METHOD FOR PRODUCING A ROTOR AND AXIAL FLUX MACHINE

(71) Applicant: Schaeffler Technologies AG & Co. KG, Herzogenaurach (DE)

(72) Inventors: Holger Witt, Bühl (DE); Matthias Gramann, Renchen (DE)

(73) Assignee: Schaeffler Technologies AG & Co. KG, Herzogenaurach (DE)

(21) Appl. No.: 17/793,716

(22) PCT Filed: Dec. 10, 2020
(86) PCT No.: PCT/DE2020/101047

§ 371 Date: Jul. 19, 2022

(30) Foreign Application Priority Data
Jan. 24, 2020 (DE) 10 2020 101 642.5

(51) Int. Cl. H02K 1/2793; H02K 1/276; H02K 15/03

(52) U.S. Cl. CPC H02K 1/2793; H02K 1/2773; H02K 15/03

(57) ABSTRACT

A rotor for an electrical axial flux machine that can be operated as a motor and/or generator includes a support, a plurality of magnet elements arranged against, on, or in the support and running radially from the interior outward. The magnet elements are magnetized in a circumferential direction and arranged individually or in groups in series around the circumference with alternating opposing magnetization directions. A plurality of flux conduction elements which conduct the magnetic flux are arranged against, on, or in the support and around the circumference, between the magnet elements. At least one conduction element arranged between two magnet elements is formed by a plurality of individual flux conduction elements, the individual flux conduction elements being formed such that they conduct the magnetic flux tangentially in a circumferential direction and block the flux in a radial direction

### CROSS-REFERENCE TO RELATED APPLICATIONS

This application is the U.S. National Phase of PCT Appin. No. PCT/DE2020/101047 filed Dec. 10, 2020, which claims priority to DE 102020101642.5 filed Jan. 24, 2020 the entire disclosures of which are incorporated by reference herein.

### TECHNICAL FIELD

The present disclosure relates to a rotor for an electric axial flux machine that can be operated as a motor and/or as a generator, comprising a support, a plurality of magnet elements arranged against, on, or in the support and extending radially from the inside outwards, wherein the magnet elements are magnetized in the circumferential direction and arranged one after the other, individually or in groups circumferentially with alternating opposing magnetization directions, and a plurality of flux conduction elements which conduct the magnetic flux and are arranged against, on, or in the support and are arranged circumferentially between the magnet elements. The disclosure further relates to a method of producing a rotor as well as an axial flux machine.

### BACKGROUND

From DE10 2013 218 829 A1 is known a rotor for an axial flux machine. With this rotor, a sort of frame is formed by the rotor laminations, in which inlays are integrated. The rotor laminations have individual punchings for both the magnets and the inlays.

Further structures of rotors for axial flux machines or of axial flux machines themselves are described, inter alia, by DE 10 2017 204 434 A1, DE 10 2005 053 119 A1, DE 10 2004 038 884 A1, DE 10 2015 208 281 A1, DE 10 2017127 157 A1 or WO 2018/015293 A1.

### SUMMARY

The disclosure is based on the object of providing a rotor for an electrical machine, a method for producing a rotor and an electrical axial flux machine which is improved with regard to the structural design of the rotor and the use of materials for the rotor with regard to costs. Advantageously, the installation space required should also at least be able to be retained or further reduced.

This object is achieved in each case by the totality of the features described herein. Advantageous further developments of the disclosure are described in the disclosure.

A rotor according to the disclosure for an electrical axial flux machine that can be operated as a motor and/or as a generator comprises a support, a plurality of magnet elements arranged against, on, or in the support and extending radially from the inside outwards, wherein the magnet elements are magnetized in a circumferential direction and arranged individually or in groups in series around the circumference with alternating opposing magnetization directions. In addition, the rotor comprises a plurality of flux conduction elements, which are arranged against, on, or in the support and are arranged circumferentially between the magnet elements and conduct the magnetic flux. According to the disclosure, at least one flux conduction element arranged between two magnet elements is formed by a plurality of individual flux conduction elements, wherein the individual flux conduction elements are designed such that they conduct the magnetic flux tangentially in the circumferential direction and substantially block same in the radial direction. This achieves the advantage that inexpensive materials can be used for the flux conduction elements while maintaining a small installation space. Furthermore, an alternative design for a rotor of an axial flux machine is specified, which previously needed to be equipped with flux conduction elements made of expensive SMC material. All flux conduction elements are particularly preferably formed by a plurality of individual flux conduction elements.

For the purposes of the disclosure, tangentially conductive and radially blocking is understood to mean that the individual flux conduction elements are embodied in such a way that the conduction thereof in a circumferentially tangential direction is considerably better than that in the radial direction. In particular, blocking in the context of the disclosure means that the ratio of conductivity from conductivity in the radial direction to conductivity in the circumferential or tangential direction is between 1:2 and 1:100, particularly preferably between 1:50 and 1:100. These ratios are heavily dependent on the absolute operating point of the electrical machine or the operating point of the flux conduction elements. With strong magnetization, a ratio closer to 1:100 will be used, while with weak magnetization, a ratio closer to 1:2 will be used.

Among the different alternatives of “against”, “on”, or “in” the support mentioned above, the following statements are meant by way of example:

“against the support”: The support is formed, for example, by an internal hub body, wherein the magnets and flux conduction elements are fastened radially on the outside of the hub body and/or are held radially on the hub body, for example by means of a ring (what is termed a barrel ring).

“on the support”: The support has a disk-shaped area or radially protruding struts or other protruding support elements on which the magnetically active components are attached (e.g., by gluing)

“in the support”: The support and the magnetically conducting elements are arranged according to the exemplary embodiment described.

An axial flux machine according to the disclosure is characterized in that the magnetic flux generated in the air gap between rotor and stator extends in the axial direction, largely parallel to the axis of rotation of the electrical machine. In other words, the air gap expands in a plane that is perpendicular to the axis of rotation of the rotor.

In a particularly preferred embodiment of the support, it has an inner ring, via which the rotor can be connected to a shaft in a rotationally fixed manner, and an outer ring, which delimits the rotor outwards in the radial direction. The support can be designed with a base part between the inner ring and the outer ring, via which the inner ring and the outer ring are connected to one another and which, together with the radial outer ring surface of the inner ring and the radial inner ring surface of the outer ring, has a receiving space open in the direction of the air gap for receiving the magnet elements and of the flux conduction elements of the rotor.

It is also possible to design the support as a hub construction that extends to the inner radius of the magnetic circuit and that is designed to be equipped with attached permanent magnets and flux conduction pieces. A barrel ring band or another method (gluing, form fit) then holds the attached permanent magnets and flux conduction pieces in position.

In another embodiment of a support, a support is provided without an outer ring and/or without a base part (virtually as a central hub part with spokes pointing radially outwards having a free end pointing radially outwards, without a limiting outer ring). The magnet elements and the flux conduction elements can be held radially inwards by gluing on the support. Alternatively or in addition to gluing, the magnet elements and the flux conduction elements can also be fixed mechanically by claw elements, which are then supported by means of struts on the inner hub-like support body.

According to an advantageous embodiment of the disclosure, it can be provided that a magnet element arranged circumferentially between two flux conduction elements is designed to increase radially outwards in the body volume thereof by increasing the axial and/or circumferential thickness thereof from the inside outwards. In the case of flux conduction elements made of laminated sheet metal or the like, the magnetic flux in the radial direction is severely restricted due to the lamination and there is hardly any compensation within the lamination between the rings, which become larger radially outwards. It is therefore advantageous to adapt the magnetic excitation depending on the radial height by varying the dimensions of the magnet elements in the radial direction. If the air gap between the stator and the rotor is divided into radially concentric rings (wherein the concentric rings are formed approximately by circumferentially adjacent individual struts of the laminated sheets), the air gap area per ring increases with increasing radius. To ensure a constant magnetic flux density in the air gap of the individual concentric rings, the magnetic excitation must increase in the radial direction (as the radius of the rings increases). The advantage of this configuration is that only as much magnetic material is used as is required for a desired homogeneous magnetic field strength within the air gap.

According to a further preferred further development of the disclosure, it can also be provided that a magnet element arranged circumferentially between two flux conduction elements has a multi-part design and is formed from a plurality of individual magnet elements of different axial thicknesses, wherein the segmentation achieves the advantage that the eddy currents within the magnet elements are reduced. It can also be achieved that identical parts of smaller magnet elements can be used for different constructions or applications or that standardized parts can be used.

Furthermore, according to a likewise advantageous embodiment of the disclosure, it can be provided that the flux conduction elements are in the form of laminated sheets, in particular made of electrical steel sheet, which in turn means that inexpensive standard materials can be used and a cost-effective alternative to the SMC material is demonstrated.

According to a further particularly preferred embodiment of the disclosure, it can be provided that the flux conduction elements are designed in such a way that they have an axial thickness that is greater than or equal to the axial thickness of the circumferentially adjacent magnet elements. In this way, the advantage can be achieved in particular that only as much material needs to be used as is required for the desired functionality, and costs, installation space, and weight can be further optimized.

Furthermore, the disclosure can also be further developed in such a way that the support has a support disk on the bottom side, which has a three-dimensional contour on the bottom side, which is designed in adaptation to the axial thickness of the magnet elements and/or the flux conduction elements in such a way that the magnet elements and the flux conduction elements, or the flux conduction elements alone, form an air gap with an unchanged axial spacing over the entire radial extension on the side thereof facing the stator. The advantage of this configuration is that the created gradation of the axial depth dimension of the support makes it possible to save on the electrical steel sheet material used, which is more expensive than the support material. Materials with a high electrical specific resistance, with a high mechanical tensile strength, and with a low specific density are preferably used as the support material. Preferred materials for this can be fiber-reinforced plastics or aluminum.

In a likewise preferred embodiment of the disclosure, it can also be provided that the base of the support on the support disk thereof is flat, such that the magnet elements, which vary in the axial thickness thereof in the radial direction, can form an air gap with changed axial spacing over the entire radial extension on the side thereof facing a stator. This has the advantage that the distance between the magnet elements and the stator is maximized without changing the axial length of the rotor. Maximizing the distance to the stator has the advantage that the eddy currents in the magnet elements due to the stator are reduced.

It can also be advantageous to further develop the disclosure such that the support has an outer support ring extending in the axial direction and an inner support ring extending in the axial direction, wherein the outer support ring has a polygonal cross-sectional shape on the radial inner ring surface thereof and/or the inner support ring has a polygonal cross-sectional shape on the radial outer ring surface thereof. The advantage that can be realized in this way is that a torque-transmitting connection between the support and the magnet elements built into the support and the flux conduction elements is created with structurally simple means.

In addition, the object of the disclosure is achieved by a method for producing a rotor for an axial flux machine, comprising the following method steps:
providing a support,
providing magnet elements and introducing the magnet elements against, on, or in the support, and
introducing flux conduction elements into the receiving spaces formed between two magnet elements, wherein a flux conduction element arranged between two magnet elements is formed by a plurality of individual flux conduction elements, and wherein the individual flux conduction elements are designed in such a way that they conduct the magnetic flux tangentially in the circumferential direction and block it in the radial direction, wherein the individual flux conduction elements are preferably formed by a plurality of laminated electrical steel sheets and which are arranged so as to extend in the circumferential direction in the longitudinal extension thereof.

Furthermore, the object of the disclosure is achieved by an axial flux machine with a rotor designed according to the disclosure.

The axial flux machine is particularly preferably designed in an H arrangement and, in addition to two rotors, comprises a stator arranged centrally between these two rotors.

### BRIEF DESCRIPTION OF THE DRAWINGS

The disclosure will be explained in more detail below with reference to figures without limiting the general concept of the disclosure.

In the figures:

FIG. 1 shows an axial flux machine according to the prior art in a perspective view in a schematic representation, with a rotor arranged between two stators,

FIG. 2 shows a further axial flux machine according to the prior art in a perspective view in a schematic representation, in an H arrangement,

FIG. 3 shows a rotor according to the disclosure in a first possible embodiment in three different views, on the top in an axial section through the axis of rotation in the area of the flux conduction elements, in the middle in a first perspective view, and in the bottom view in a second perspective view wherein parts of the support are not equipped with magnet elements and flux conduction elements, each in a schematic representation,

FIG. 4 shows the rotor according to FIG. 2, in the illustration on the left in a perspective view with a partial axial section and in the illustration on the right in an axial section through the axis of rotation in the area of the magnet elements,

FIG. 5 shows a rotor according to the disclosure in a second possible embodiment in three different views, above in an axial section through the axis of rotation in the area of the flux conduction elements, in the middle in a first perspective view, and in the bottom view in a second perspective view wherein parts of the support are not equipped with magnet elements and flux conduction elements, each in a schematic representation, and

FIG. 6 shows the rotor according to FIG. 5, in the top illustration in a perspective view with a partial axial section and in the bottom illustration in an axial section of the axis of rotation in the region of the magnet elements.

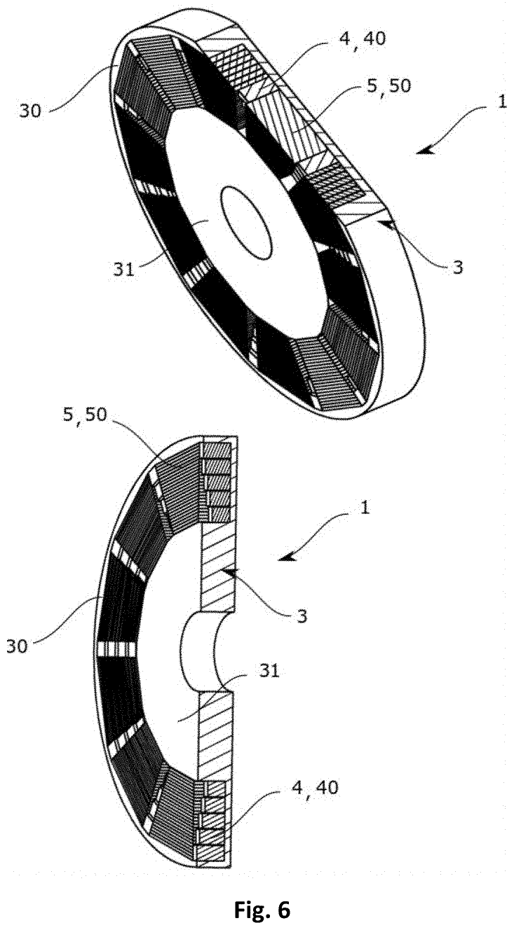

### DETAILED DESCRIPTION

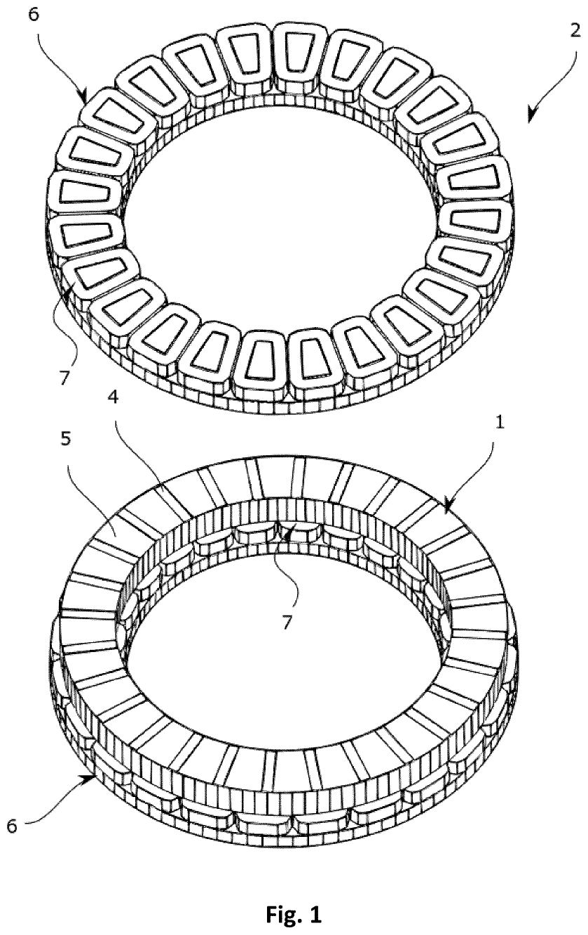

FIG. 1 shows an axial flux machine according to the prior art in a perspective view in a schematic representation, with a rotor 1 arranged between two stators 6 in the basic structure thereof. The axial flux machine 2 comprises a rotor 1, which is shown here schematically without the support parts thereof but with magnet elements 4 and flux conduction elements 5 that follow one another in alternation around the circumference. In the top illustration, a first stator 6 is shown in a plan view from the inside, so that the individual stator coils of the stator 6 can be clearly seen. In each case, two adjacent stator coils are advantageously connected together, wherein three stator coil packs each driven offset by 120 angular degrees result over a total of six adjacent stator coils. If the first stator 6, in the top illustration, were folded down by 180 degrees and kept axially spaced apart from the rotor 1 while forming a first air gap 7, the uniform, compact axial flux machine would result in the “assembled” state. The bottom illustration shows a plan view of the remaining stator-rotor packet, wherein the second stator 6 is arranged below the rotor 1, axially spaced apart by a second air gap 13.

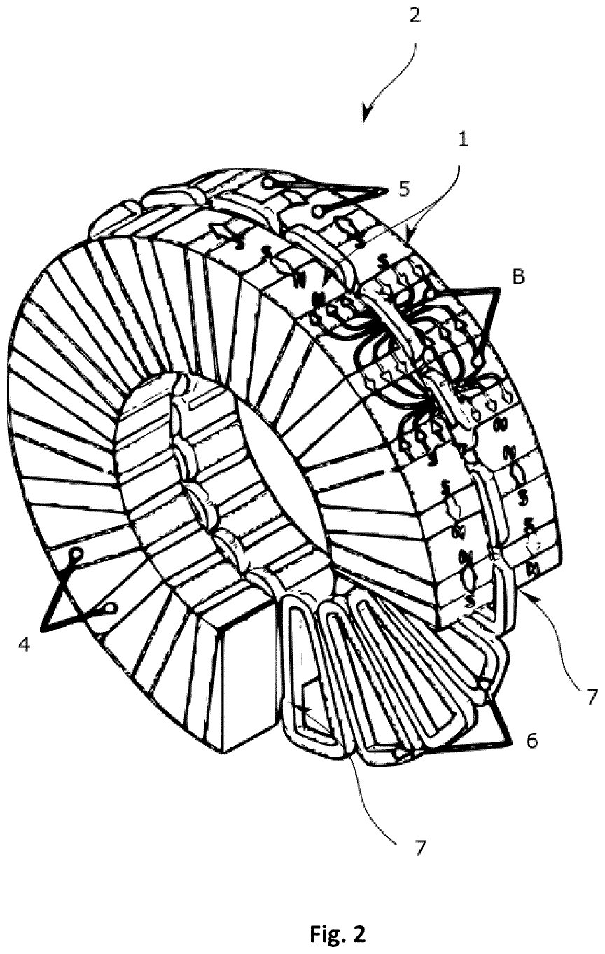

FIG. 2 shows a further axial flux machine 2 according to the prior art in a perspective view in a schematic representation, in an H arrangement. In this case, a rotor 1 is arranged axially on both sides of a centrally arranged stator 6 with stator coils, each spaced apart by an air gap 7.

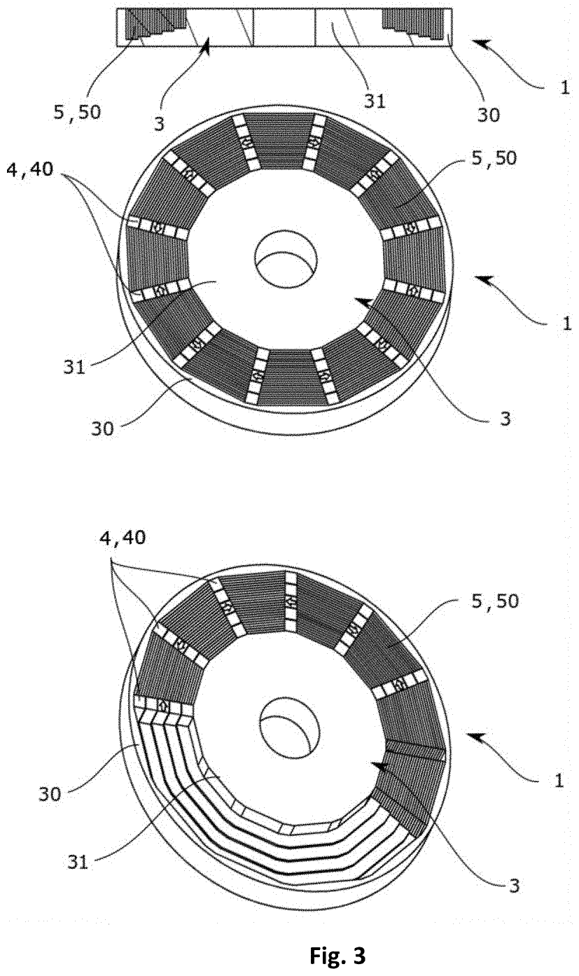

FIG. 3 shows a rotor 1 according to the disclosure in a first possible embodiment in three different views. In the top view, the rotor 1 is shown in an axial section through the axis of rotation in the area of the flux conduction elements 5. In the middle view, the rotor 1 is shown in a first perspective view, and in the bottom view in a second perspective view, wherein parts of the support 3 are not equipped with magnet elements 4 and flux conduction elements 5 in the bottom view. The rotor 1 comprises a support 3 designed in the manner of an annular disk, a plurality of magnet elements 4 arranged in the support 3 and extending radially inside the support 3 from the inside to the outside. The support 3 has an inner ring, via which the rotor can be connected to a shaft in a rotationally fixed manner, and has an outer ring, which delimits the rotor outwards in the radial direction. The support 3 is formed between the inner ring and the outer ring with a base part, via which the inner ring and the outer ring are connected to one another and which, together with the radial outer ring surface of the inner ring and the radial inner ring surface of the outer ring, forms a receiving space open in the direction of the air gap for receiving the magnet elements 4 and the flux conduction elements 5 of the rotor 1.

The magnet elements 4 are magnetized in the circumferential direction in the direction of the arrows drawn in the magnet elements 4, and shown individually in the exemplary embodiment, each radial row for itself, are arranged in a circumferential direction with alternating opposing magnetization directions. Furthermore, a plurality of flux conduction elements 5, which are arranged circumferentially between the magnet elements 4 and conduct the magnetic flux, are arranged in the support 3, wherein each flux conduction element 5 is formed by a plurality of individual flux conduction elements 50. The individual flux conduction elements 50 of a flux conduction element 5 arranged between two magnet elements 4 are designed as individual electrical steel sheets with different dimensions. The individual sheets are stacked one behind the other in the radial direction to form a block.

A magnet element 4 arranged circumferentially between two flux conduction elements 5 is designed to become larger in the body volume thereof radially outwards, in that the axial and/or circumferential/tangential thickness thereof increases from the inside outwards. The figure also clearly shows that a magnet element 4 has a multi-part design and is formed from a plurality of individual magnet elements 40 of different axial thicknesses.

In the exemplary embodiment according to FIG. 3, the depth dimension (in the axial direction) of both the flux conduction elements 5 or the individual flux conduction elements 50 and the magnet elements 4 or the individual magnet elements 40 was varied depending on the height in the radial direction. A stair shape is thus formed, seen in cross-section, wherein the stair descends radially outwards from the inside. This is shown for the flux conduction elements 5 in the upper axial section illustration. The middle view shows the direction of lamination of the flux conduction elements 5, as well as the arrangement and direction of magnetization of the magnet elements 4. Individual magnet elements 4 and flux conduction elements 5 are hidden in the lower view, so that the adapted shape of the support 3 can also be seen. This approximates a dodecagon on the inner radius delimiting the receiving space for the magnet elements 4 and the flux conduction elements 5 in the radial direction, as well as on the outer radius, so that the inner radius is adapted to the profile of the contours of the magnet elements 4 and flux conduction elements 5. The rear wall or the bottom part of the support 3 is also adapted to the depth dimension of the magnet elements 4 and the flux conduction elements 5. The figure also shows that the flux conduction elements 5 are designed in such a way that they have an axial thickness that is essentially the same as the axial thickness of the circumferentially adjacent individual magnet elements 40 of a magnet element 4, so that towards the air gap a uniform uninterrupted surface is formed with the same air gap dimension through the magnet elements 4 and the flux conduction elements 5.

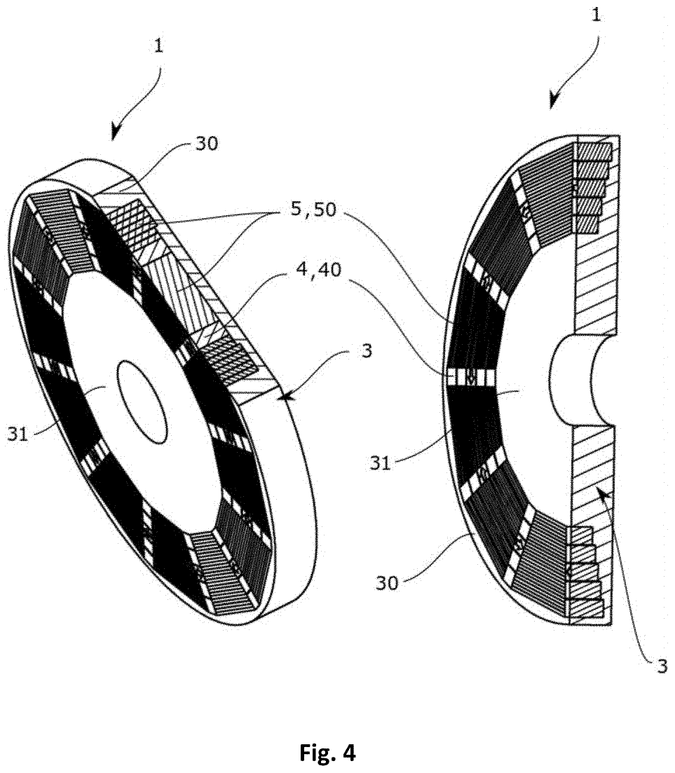

FIG. 4 shows the rotor 1 according to FIG. 3, in the illustration on the left in a perspective view with a partial axial section, and in the illustration on the right in an axial section through the axis of rotation in the area of the magnet elements 4. The gradation of the depth dimension of the magnet elements 4 or the different axial thickness of the individual magnet elements 40 as a function of the radial height can be clearly seen in the illustration on the right.

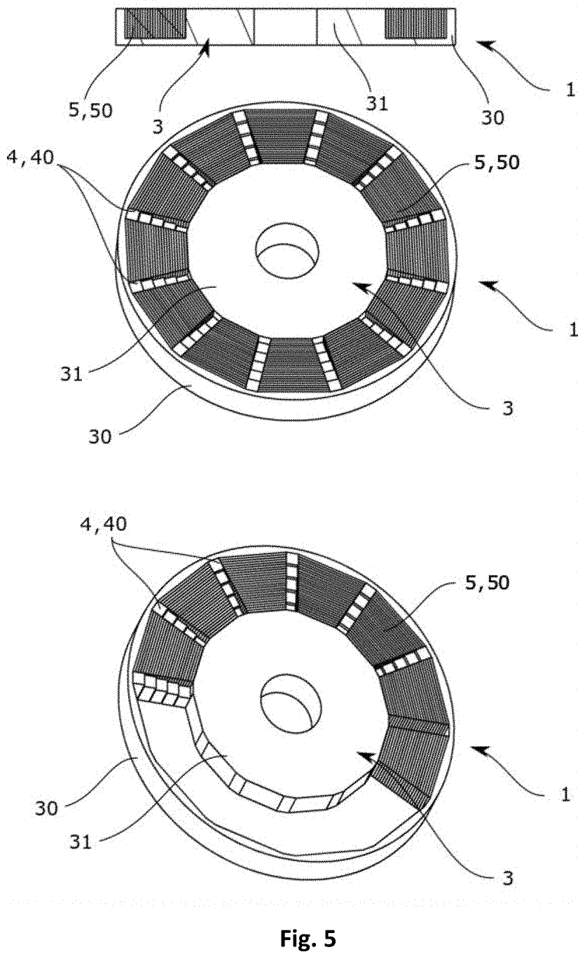

FIG. 5 shows a rotor 1 according to the disclosure in a second possible embodiment in three different views. In the view above, the rotor 1 is shown in an axial section through the axis of rotation, in the area of the flux conduction elements 5. The middle view shows the rotor 1 in a first perspective view, and the bottom view shows a second perspective view, wherein parts of the support 3 are not equipped with magnet elements 4 and flux conduction elements 5 in the bottom view. In this embodiment, the base of the support 3 is flat on the support disk thereof, such that the magnet elements 4, which vary in the axial thickness thereof in the radial direction, can form an air gap 7 with a changed axial spacing over the entire radial extension on the side thereof facing a stator 6. FIG. 5 shows an exemplary embodiment in which the variation in the depth of the magnet elements 4 in the axial direction is not arranged on the rear side of the rotor 1 but on the side facing the air gap 7. For the rest, those statements that have already been made for the first exemplary embodiment apply to the individual components of the second exemplary embodiment.

The disclosure is not limited to the embodiments shown in the figures. The above description is therefore not to be regarded as limiting, but rather as explanatory. The following claims are to be understood as meaning that a named feature is present in at least one embodiment of the disclosure. This does not exclude the presence of further features. If the patent claims and the above description define “first” and “second” features, this designation serves to distinguish between two features of the same type without defining an order of precedence.

### LIST OF REFERENCE SYMBOLS

1 Rotor

2 Axial flux machine

3 Support

4 Magnet element

5 Flux conduction element

6 Stator

7 Air gap

30 Support outer ring

31 Support inner ring

40 Single magnet element

50 Individual flux conduction element

1. A rotor for an electric axial flux machine operable as a motor or as a generator, the rotor comprising:
a support,
a plurality of magnet elements arranged against, on or in the support and extending radially from an inside outwards, wherein the magnet elements are magnetized in a circumferential direction and are arranged individually or in groups in series around a circumference with alternating opposing magnetization directions,
and a plurality of magnetic flux conducting flux conduction elements which are arranged against, on or in the support and which are circumferentially arranged between the magnet elements,
wherein:
at least one flux conduction element arranged circumferentially between two magnet elements is formed by a plurality of individual flux conduction elements, wherein the individual flux conduction elements are designed in such a way that they conduct a magnetic flux tangentially in the circumferential direction and substantially block same in a radial direction

2. The rotor according to claim 1, wherein:
a magnet element arranged circumferentially between two flux conduction elements is designed to become larger radially outwards in a body volume thereof in that an axial and/or circumferential tangential thickness thereof increases from the inside outwards.

3. The rotor according to claim 1, wherein:
a magnet element arranged circumferentially between two flux conduction elements has a multi-part design and is formed from a plurality of individual magnet elements of different axial thicknesses.

4. The rotor according to claim 1, wherein:
the flux conduction elements are in a form of laminated sheets.

5. The rotor according to claim 1, wherein:
the flux conduction elements are designed in such a way that they have an axial thickness that is greater than or equal to the axial thickness of circumferentially adjacent magnet elements.

6. The rotor according to claim 1, wherein:
the support has a three-dimensional contour on a base-side support disk thereof, which is designed in adaptation to an axial thickness of the magnet elements and/or of the flux conduction elements in such a way that the magnet elements and the flux conduction elements or the flux conduction elements alone form an air gap with an unchanged axial spacing over an entire radial extension on a side thereof facing a stator.

7. The rotor according to claim 1, wherein:
the support is flat on a base side of a support disk thereof in such a way that the magnet elements, which vary in an axial thickness thereof in the radial direction, can form an air gap with a changed axial spacing over an entire radial extension on a side thereof facing a stator.

8. The rotor according to claim 1, wherein:
the support has an outer support ring extending in the axial direction and an inner support ring extending in the axial direction, wherein the outer support ring has a polygonal cross-sectional shape on a radial inner annular surface thereof and/or the inner support ring has a polygonal cross-sectional shape on a radial ring outer surface thereof.

9. A method for producing a rotor, comprising:
providing a support,
providing magnet elements and introducing the magnet elements against, on, or in the support, and
introducing a flux conduction element into a receiving space formed between two magnet elements, wherein the flux conduction element arranged between two magnet elements is formed by a plurality of individual flux conduction elements and wherein the individual flux conduction elements are designed in such a way that they tangentially conduct a magnetic flux in a circumferential direction and block same in a radial direction, wherein the individual flux conduction elements are formed by a plurality of laminated electrical steel sheets and these are arranged to extend a longitudinal extension thereof in the circumferential direction.

10. An axial flux machine, comprising:
a stator; and
a rotor comprising:
a support having a support disk on a bottom side; and
a plurality of magnet elements arranged against on or in the support and extending radially from an inside outwards, wherein the support is flat on a base side of the support disk in such a way that the magnet elements, which vary in an axial thickness thereof in a radial direction, form an air gap with a changed axial spacing over an entire radial extension on a side thereof facing the stator.

11. The axial flux machine according to claim 10, further comprising:
a plurality of magnetic flux conducting flux conduction elements arranged against, on or in the support and circumferentially arranged between the magnet elements.

12. The axial flux machine according to claim 11, wherein a magnet element arranged circumferentially between two flux conduction elements has a multi-part design and is formed from a plurality of individual magnet elements of different axial thicknesses.

13. A rotor for an electric axial flux machine, the rotor comprising:
a support having a support disk on a bottom side;
a plurality of magnet elements arranged against, on or in the support and extending radially from an inside outwards, wherein the support is flat on a base side of the support disk in such a way that the magnet elements, which vary in an axial thickness thereof in a radial direction, form an air gap with a changed axial spacing over an entire radial extension on a side thereof facing a stator; and
a plurality of magnetic flux conducting flux conduction elements arranged against, on or in the support and circumferentially arranged between the magnet elements.

14. The rotor according to claim 13, wherein a magnet element arranged circumferentially between two flux conduction elements has a multi-part design and is formed from a plurality of individual magnet elements of different axial thicknesses.

15. The rotor according to claim 13, wherein at least one flux conduction element arranged circumferentially between two magnet elements is formed by a plurality of individual flux conduction elements, wherein the individual flux conduction elements are designed in such a way that they conduct a magnetic flux tangentially in the circumferential direction and substantially block same in a radial direction.
